(19) United States
(12) Patent Application Publication
(10) Pub. No.: US 2026/0095427 A1
(43) Pub. Date: Apr. 2, 2026

(54) Methods and Systems for Sending Communications

(71) Applicant: Xero Limited, Te Aro, Wellington (NZ)

(72) Inventors: Soon-Ee Cheah, Te Aro, Wellington (NZ); Jiun Siew, Te Aro, Wellington (NZ)

(21) Appl. No.: 19/111,547

(22) PCT Filed: Sep. 13, 2023
(86) PCT No.: PCT/NZ2023/050097

§ 371 Date: Mar. 13, 2025

(30) Foreign Application Priority Data
Sep. 14, 2022 (AU) 2022902661

(51) Int. Cl. H04L 51/18; G06Q 30/02

(52) U.S. Cl. CPC H04L 51/18; G06Q 30/02

(57) ABSTRACT

A method for sending a communication to a recipient device comprises selecting an initial communication from a subset of communications based on a selection algorithm, wherein the selection algorithm uses at least one stored parameter; sending the selected communication to the recipient device; observing any actions taken by the recipient in response to the communication; determining whether the communication resulted in a successful outcome; and updating the at least one stored parameter based on the observed action. A successful outcome is determined based on comparing the actions taken by the recipient in response to the communication with one or more desired actions.

### CROSS-REFERENCE TO RELATED APPLICATION(S)

This application is a national stage 371 application of PCT/NZ2023/050097, filed on Sep. 13, 2023, which claims priority to and the benefit of Australian Patent Application Serial No. 2022902661, filed Sep. 14, 2022, the entire disclosures of which are hereby incorporated by reference.

### TECHNICAL FIELD

Embodiments generally relate to methods and systems for selecting and sending communications to be delivered to one or more recipients. In particular, described embodiments are directed to methods and systems for selecting communications that prompt action to be taken by one or more recipients in response to receiving the delivered communications.

### BACKGROUND

Organisations commonly send many communications to their staff, clients, customers and other networks. Many such communications include a call to action prompting the recipient to act in response to the message, such as by following an interactive link, for example. While it may be desirable to have most or all recipients respond to the communication by taking the suggested action, many recipients may ignore such communications, especially when they may receive many such communications every day.

It is desired to address or ameliorate one or more shortcomings or disadvantages associated with prior methods and systems for increasing user interaction in response to delivered communications, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a method for sending a communication to a recipient device, the method comprising:
selecting an initial communication from a subset of communications based on a selection algorithm, wherein the selection algorithm uses at least one stored parameter;
sending the selected communication to the recipient device;
observing any actions taken by the recipient in response to the communication;
determining whether the communication resulted in a successful outcome; and
updating the at least one stored parameter based on the observed action;
wherein a successful outcome is determined based on comparing the actions taken by the recipient in response to the communication with one or more desired actions.

In some embodiments, the selection algorithm comprises a weighted selection method.

In some embodiments, the weighted selection method comprises an epsilon-greedy method.

According to some embodiments, the stored parameter comprises a running average parameter, and where the running average parameter stores the number of times each communication has had a successful outcome divided by the number of times the communication has been sent.

In some embodiments, the weighted selection method comprises a Thompson sampling method.

According to some embodiments, the stored parameter comprises at least one parameter of a beta distribution.

According to some embodiments, the stored parameter comprises an alpha parameter equivalent to the number of times the communication has had a successful outcome.

According to some embodiments, the stored parameter comprises a beta parameter equivalent to the number of times the communication has had an unsuccessful outcome.

In some embodiments, the weighted selection method comprises a contextual Thompson sampling method, and the at least one stored parameter is updated using a Laplace approximation.

According to some embodiments, the stored parameter comprises at least one parameter of a multivariate normal distribution.

According to some embodiments, the stored parameter comprises a mode of a multivariate normal distribution.

According to some embodiments, the stored parameter comprises a Hessian matrix.

In some embodiments, the weighted selection method comprises a Bernoulli method.

In some embodiments, observing any actions taken by the recipient in response to the communication comprises observing whether any data is received from the recipient device in response to the communication.

In some embodiments, observing any actions taken by the recipient in response to the communication comprises observing a change in a calculated lifetime value of a user account associated with the recipient device.

Some embodiments further comprise calculating a lifetime value of a user account based on at least one of: how long the user account has been active; how often a user logs into their account; which features the user uses; how often a user spends money; and how much money the user spends,

In some embodiments, the at least one stored parameter is part of a stored model, and wherein updating the at least one stored parameter based on the observed action comprises updating the model based on the observed action.

### BRIEF DESCRIPTION OF THE DRAWINGS

Embodiments are described in further detail below, by way of example and with reference to the accompanying drawings, in which:

FIG. 1 shows a block diagram of a system for selecting communications according to some embodiments;

FIG. 2 shows a flowchart of a method performed by the system of FIG. 1 to select and send communications according to some embodiments;

FIG. 3 shows a flowchart of an alternative method performed by the system of FIG. 1 to select and send communications according to some embodiments;

FIG. 4 shows a flowchart of a method performed by the system of FIG. 1 to select a message to send, as might be performed during the method shown in FIG. 2, according to some embodiments;

FIG. 5 shows a flowchart of an alternative method performed by the system of FIG. 1 to select a message to send, as might be performed during the method shown in FIG. 2, according to some embodiments;

FIG. 6 shows a flowchart of a further alternative method performed by the system of FIG. 1 to select a message to send, as might be performed during the method shown in FIG. 2, according to some embodiments;

FIG. 7A shows an example graph illustrating a subset of messages that were sent for the purpose of conducting a trial;

FIG. 7B shows an example graph illustrating a prior distribution for the trial conducted with the messages of FIG. 7A;

FIG. 8A shows an example graph illustrating the outcomes of the trial of 100 messages sent by the system of FIG. 1 selected from the messages of FIG. 7A; and

FIG. 8B shows an example graph illustrating the cumulative number of messages sent in the trial illustrated by FIG. 8A.

### DETAILED DESCRIPTION

Embodiments generally relate to methods and systems for selecting communications to be delivered to one or more recipients. In particular, described embodiments are directed to methods and systems for selecting communications that prompt action to be taken by one or more recipients in response to receiving the delivered communications.

It is often desirable to have recipients take an action in response to receiving a communication or message. This action may be to interact with a component of the message, such as a hyperlink, and optionally to perform an action on the webpage the hyperlink directs them to, such as by making a purchase, filling out a form, submitting information, or accepting terms and conditions, for example. In some embodiments, the action may be to take an action other than interacting with a component of the message. For example, the user may be directed to perform an action such as visiting a webpage, logging in to an account, or taking another action that does not require them to directly interact with the message.

Described embodiments relate to systems and methods for selecting communications and messages to send to recipients. In particular, described embodiments relate to systems and methods for selecting effective messages to send to recipients, where an effective message increases the chance of a recipient of the message performing a desired action. Where a predetermined number of messages are available to select from, and a successful message is one that results in a particular outcome or result, described embodiments may be directed towards methods and systems that seek to maximise the cumulative number of times that a successful message is sent over a particular number of periods or trials.

This can be done by recording outcomes for messages sent over time, and labelling messages as effective when they result in desired outcomes more than other tested messages. However, in order to allow for new messages to be tested, described methods and systems may implement a process that includes both ‘exploring’ and ‘exploiting’ steps. The exploring steps may be used to test new messages and re-test older messages, while the exploiting steps may be used to maximise the number of effective messages sent. According to some embodiments, a reinforcement learning method may be implemented, where a model is trained over time to reinforce the selection of effective messages for sending.

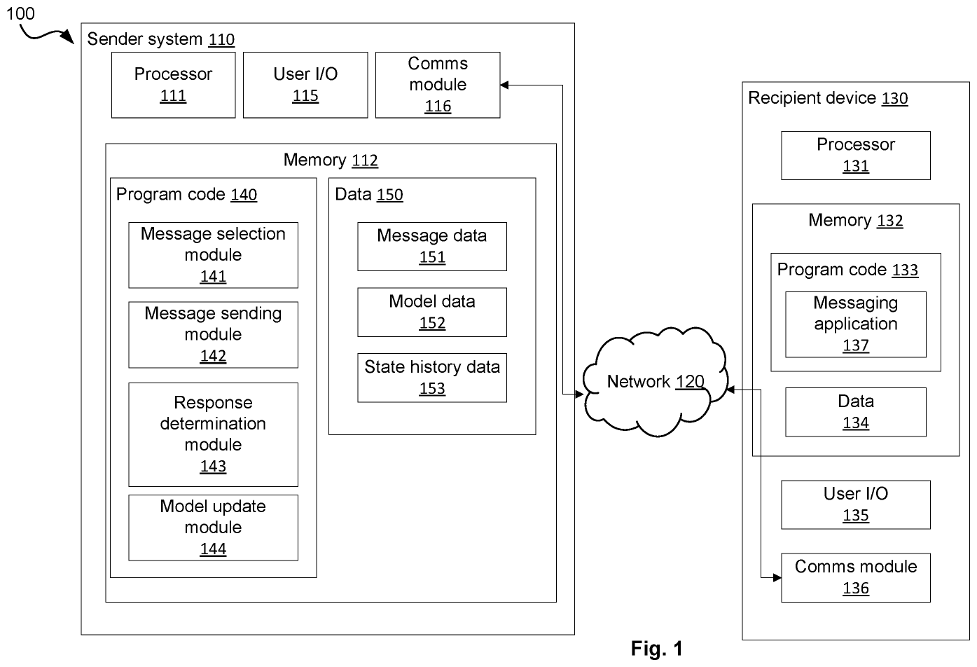

Described methods may be carried out by the system of FIG. 1.

FIG. 1 shows a system 100 for selecting communications, and sending the selected communications to recipients. System 100 includes at least one sender system 110. Sender system 110 is configured to select and send communications to at least one recipient device 130 across a network 120. According to some embodiments, system 100 may include multiple sender systems 110 and/or multiple recipient devices 130.

Sender system 110 may comprise one or more computing devices and/or server devices, such as one or more servers, databases, and/or processing devices in communication over a network. According to some embodiments, sender system 110 may comprise a cloud based server system. While a single sender system 110 is shown, sender system 110 may comprise multiple systems of servers, databases, and/or processing devices in some embodiments. Sender system 110 may be used by an entity or organisation that wishes to send communications to one or more recipient devices, and particularly wants recipients to take at least one action in response to such a communication.

Sender system 110 comprises a processor 111 configured to read and execute program code. Processor 111 may include one or more data processors for executing instructions, and may include one or more of a microprocessor, microcontroller-based platform, a suitable integrated circuit, and one or more application-specific integrated circuits (ASICs).

Sender system 110 further comprises at least one memory 112. Memory 112 may include one or more memory storage locations, and may be in the form of read-only memory (ROM), random access memory (RAM), flash or other memory types. Memory 112 is arranged to be accessible to processor 111, and to store data 150 that can be read and written to by processor 111. Memory 112 may also contain program code 140 that is executable by processor 111, to cause processor 111 to perform various functions.

Sender system 110 may further comprise user input and output peripherals 135. These may include one or more of a display screen, touch screen display, mouse, keyboard, speaker, microphone, and camera, for example. User I/O 115 may be used to receive data and instructions from a user, and to communicate information to a user.

Sender system 110 also comprises a communications module 116, to facilitate communication between sender system 110 and other remote or external devices.

Communications module 116 may allow for wired or wireless communication between sender system 110 and external devices, and may utilise Wi-Fi, universal serial bus (USB), Bluetooth, or other communications protocols. According to some embodiments, communications module 116 may facilitate communication between sender system 110 and recipient device 130, for example.

Network 120 may comprise one or more local area networks or wide area networks that facilitate communication between elements of system 100. For example, according to some embodiments, network 120 may be the internet. However, network 120 may comprise at least a portion of any one or more networks having one or more nodes that transmit, receive, forward, generate, buffer, store, route, switch, process, or a combination thereof, etc. one or more messages, packets, signals, some combination thereof, or so forth. Network 120 may include, for example, one or more of: a wireless network, a wired network, an internet, an intranet, a public network, a packet-switched network, a circuit-switched network, an ad hoc network, an infrastructure network, a public-switched telephone network (PSTN), a cable network, a cellular network, a satellite network, a fibre-optic network, or some combination thereof.

Recipient device 130 may be a computing device such as a personal computer, laptop computer, desktop computer, tablet, or smart phone, for example. Recipient device 130 may be used by a user who is subscribed to receive messages from sender system 110, or is part of a community or group that is related to system 100 such that the operators of sender system 110 may wish to send messages to the user of recipient device 130.

Recipient device 130 comprises a processor 131 configured to read and execute program code. Processor 131 may include one or more data processors for executing instructions, and may include one or more of a microprocessor, microcontroller-based platform, a suitable integrated circuit, and one or more application-specific integrated circuits (ASICs).

Recipient device 130 further comprises at least one memory 132. Memory 132 may include one or more memory storage locations, and may be in the form of ROM, RAM, flash or other memory types. Memory 112 is arranged to be accessible to processor 131, and to store data 134 that can be read and written to by processor 131. Memory 132 may also contain program code 133 that is executable by processor 131, to cause processor 131 to perform various functions. Program code 133 may include a messaging application 137, which may be one or more of an email application, short message service (SMS) application, other messaging application or web browser application capable of accessing webpages with messaging functions.

Recipient device 130 may further comprise user input and output peripherals 135. These may include one or more of a display screen, touch screen display, mouse, keyboard, speaker, microphone, and camera, for example. User I/O 115 may be used to receive data and instructions from a user, and to communicate information to a user.

Recipient device 130 also comprises a communications module 136, to facilitate communication between recipient device 130 and other remote or external devices.

Communications module 136 may allow for wired or wireless communication between recipient device 130 and external devices, and may utilise Wi-Fi, USB, Bluetooth, or other communications protocols. According to some embodiments, communications module 136 may facilitate communication between recipient device 130 and sender system 110, for example.

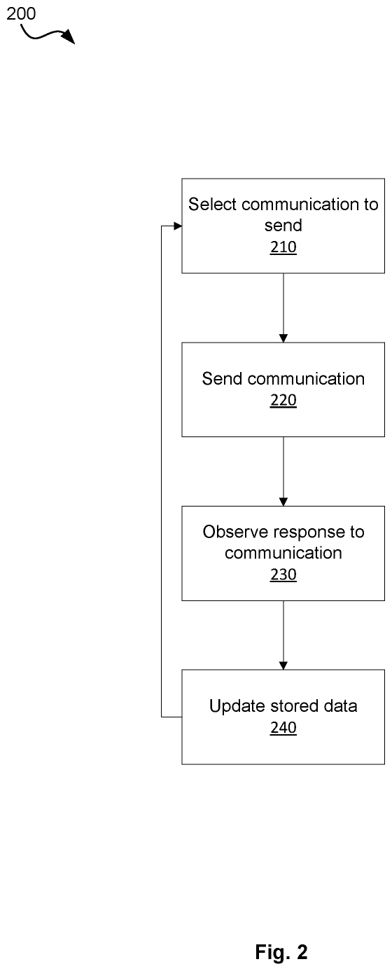

FIG. 2 shows a flow diagram illustrating a method 200 of selecting and sending messages using system 100, as performed by processor 111 of sender system 110 executing instructions stored in memory 112.

At step 210, processor 111 executing message selection module 141 selects a communication to be sent to one or more recipient devices 130. Processor 111 may select a communication from a set of possible communications or messages stored in message data 151, for example. The communication may be selected using a weighted selection method, which may balance selecting communications for exploring purposes and selecting communications for exploiting purposes, in some embodiments. The weighted selection method may be based on a message success model, as stored in model data 152. According to some embodiments, the weighted selection method may be one of an epsilon-greedy method, a Thompson sampling method, a Bernoulli method, or another weighted selection method.

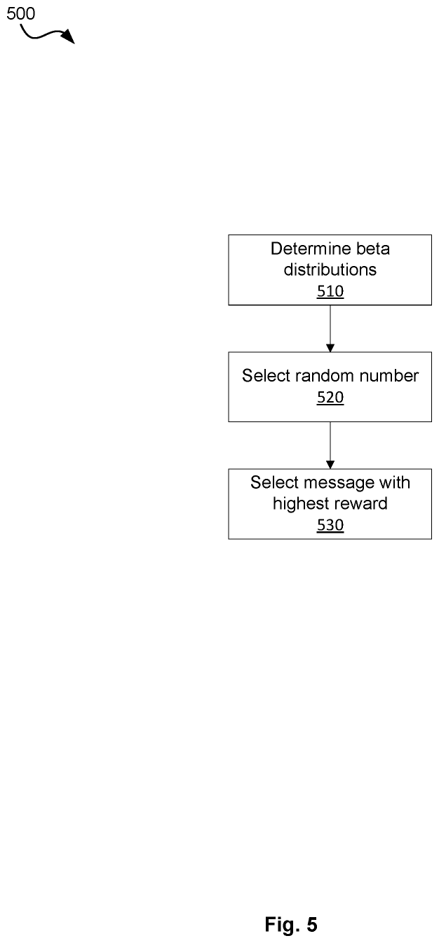

Some example weighted selection methods are described below with reference to FIGS. 5 to 8B.

Once a communication is selected from the set of messages stored in message data 151, at step 220 processor 111 executing message sending module 142 may be caused to send the communication to one or more recipient devices 130 via communications module 146. The communication may be in the form of an email, SMS, messenger message, in-app message, pop-up or notification, and may be sent via network 120. Each recipient device 130 may receive the communication via communications module 116, and may be caused to display the message to a user via user I/O 115.

At step 230, processor 111 executing response determination module 143 may be caused to observe and record any response to the message by recipient device 130. For example, this may be by detecting that the user of recipient device 130 has interacted with a link provided in the sent communication. This may be detected by observing that recipient device 130 has been caused to load a webpage associated with the link provided in the message, for example. Processor 111 may be configured to observe any events triggered based on an action of the user of recipient device 130 that result in data being sent from recipient device 130 to the sender system 110, or result in a change in one or more systems accessible to sender system 110. According to some embodiments, any communication that results in an action, interaction or response by the recipient may be considered a “successful” communication. In some embodiments, a successful communication may require a specific response, such as following a link, purchasing a product or providing information, for example.

At step 240, processor 111 executing model update module 144 updates stored data based on the data received or determined at step 230. This may include updating one or more parameters stored in message data 151, as well as updating the model as stored in model data 152.

Message data 151 may be updated to record a score or value against the record corresponding to the communication selected and sent at steps 210 and 220. For example, the success of the communication may be recorded as a numerical value, such as assigning a 1 to successful communications, and a 0 to unsuccessful communications, for example. Such a numerical value may be considered a success parameter, in some embodiments.

According to some embodiments, where an epsilon-greedy algorithm is being used, processor 111 may calculate and store a running average parameter for each message stored in message data 151, where the running average is calculated as the number of times the communication has had a successful outcome divided by the number of times the message has been sent.

According to some embodiments, where a Thompson sampling algorithm is being used, processor 111 may calculate and store two parameters of a beta distribution for each message stored in message data 151. The first parameter may be equivalent to the number of times the communication has had a successful outcome, which may be referred to as the alpha parameter, or a. The second parameter may be the number of times the communication has had an unsuccessful outcome, which may be referred to as the beta parameter, or B.

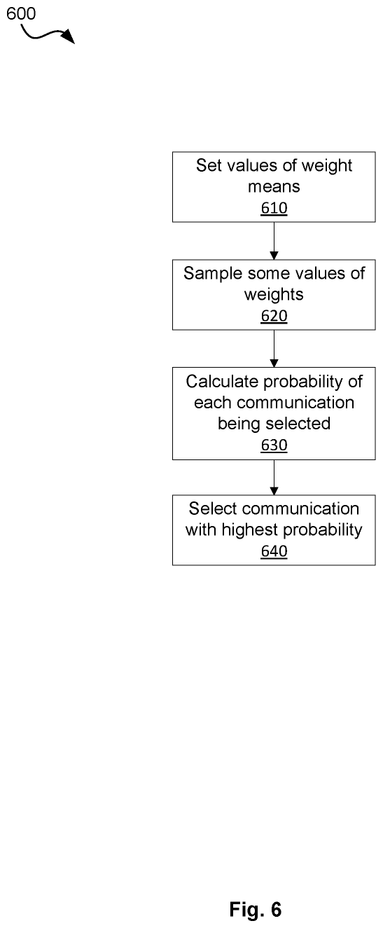

According to some embodiments, where a contextual Thompson sampling algorithm is being used, processor 111 may calculate and store two parameters of a multivariate normal distribution for each message stored in message data 151. The first parameter may be a mode of a distribution *w, and the second parameter may be a Hessian matrix H. According to some embodiments, processor 111 may update these parameters based on an observed response to one or more sent messages using a Laplace approximation, which is described in further detail below with reference to FIG. 6.

Model data 152 may be updated based on any responses received since the last update to the model. Processor 111 may be configured to update model data 152 in order to increase the chances of ‘success’ for future sent communications. How the model is updated by processor 111 will depend on the model stored in model data 152 and the weighted selection method being used at step 210. For example, where weighted selection method is a Thompson sampling method, model data 152 may be updated based on Thompson sampling. According to some embodiments, the update may also be based on contextual metadata. For example, when using Thompson sampling, model data 152 may include additional contextual information, and processor 111 may be caused to update model data 152 by updating stored coefficients of a logistic regression based on a batch of input data as received or determined at step 230.

Having updated the data, processor 111 may return to step 210, selecting a new message to send based on the updated data.

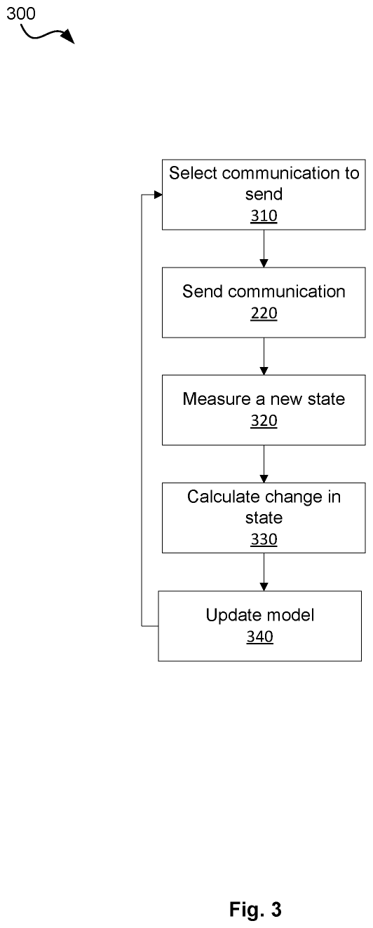

FIG. 3 shows a flow diagram illustrating an alternative method 300 of sending messages using system 100, as performed by processor 111 of sender system 110 executing instructions stored in memory 112. While method 200 of FIG. 2 takes into account engagement with sent communications, it may not take into account the different values that different responses may have. For example, a response to a communication that results in a user making a purchase may have a higher value than a response that causes a user to simply browse an online shop. In order to have a fair and consistent valuation of communications, the value of responses should be taken into account along with engagement. Method 300 of FIG. 3 causes communications to be selected not only based on previous engagement with the communications, but a determined value of that engagement.

In particular, method 300 of FIG. 3 may involve calculating a lifetime value for each user or user account to which communications are sent by sender system 110. The lifetime value may be a score that is updated on a regular basis in response to user behaviour, and may predict a customer or user's lifetime value, which may be in terms of the total amount of money they are expected to spend with the organisation operating sender system 110. According to some embodiments, the lifetime value may directly or indirectly model the retention of one or more users or customers.

The lifetime value may be determined using an algorithm or via a modelling process. According to some embodiments, the lifetime value may be determined using a stored model which may be trained offline using standard supervised learning methods such as linear regression. The model may use contextual data such as user demographics and historical behaviour to determine a lifetime value for each user. The algorithm or model may take into account factors such as how long the user has been a member or subscriber, how often a user logs into their account, which features the user used, how often a user spends money, and how much money the user spends, for example.

As not all communications are equal, and not all responses are equally valuable, calculating a lifetime value for each customer or message recipient allows for certain communications and correlating actions or responses to be given greater weight than others. For example, a newsletter, promotional or marketing communication may have a response with less value than the response to an operational or security message, and the value of such responses may be reflected in the determined lifetime value based on any actions taken by the recipient in response to such a communication. Lifetime value may be determined based on a number of factors, including conversion (e.g. whether a trial user converted to a paid subscriber), retention (i.e. whether a subscriber remains subscribed), ongoing subscription fees paid and any additional add-ons purchased. According to some embodiments, the lifetime value may be modelled using a zero-inflated model, where a customer's lifetime value may be 0 if they don't “convert” to a paying user, or the predicted lifetime value if they do.

At step 310, processor 111 executing message selection module 141 selects a communication to be sent to one or more recipient devices 130. According to some embodiments, processor 111 may do this by selecting a message which is predicted to have the most significant positive effect on a lifetime value of one or more customers to whom the communication is to be sent.

Specifically, processor 111 may start by executing response determination module 143 to measure a current state of one or more aspects of system 100 or an external system. For example, processor 111 may measure a current lifetime value of each customer to whom the communication is to be sent. In some alternative embodiments, processor 111 may measure a current state of a database storing information about subscribers to a particular service, according to some embodiments. Data relating to the current state may be stored by processor 111 in state history data 153.

Processor 111 may then analyse each communication in a subset of possible communications to be sent to predict what effect the sending of each message is likely to have on the lifetime value of each of the customers to whom the communication is to be sent. Processor 111 may execute a model stored in model data 152 to predict the effect of each communication on the lifetime value.

Processor 111 executing message selection module 141 may then select the communication that has the largest positive predicted effect on the lifetime value of one or more of the customers to whom the communication is to be sent.

At step 220, processor 111 executing message sending module 142 may be caused to send the communication to one or more recipient devices 130 via communications module 146, as described above with reference to FIG. 2.

At step 320, processor 111 executing response determination module 143 may be configured to measure a new state of the one or more aspects of system 100 or the external system as originally measured at step 320. For example, processor 111 may measure a new state of a lifetime value of each customer to whom the communication was sent. In some alternative embodiments, processor 111 may measure a new state of a database storing information about subscribers to a particular service, which may allow processor 111 to determine whether any new subscribers have been added, or whether any subscribers have updated their details or upgraded their plan, for example. Data relating to the new state may be stored by processor 111 in state history data 153.

At step 330, processor 111 executing response determination module 143 is caused to calculate a change in state based on the difference between the state determined by processor 111 at step 310 and the state determined by processor 111 at step 320. For each recipient of a communication sent at step 220, the change in state may be a positive change, such as an increase in lifetime value, or a negative change, such as a decrease in lifetime value.

At step 340, processor 111 executing model update module 144 updates the model as stored in model data 152 based on the lifetime value determined as the change in state at steps 320 and 330. According to some embodiments, processor 111 would update model data 152 to reflect the actual change in state as calculated at step 330 to allow for better future predictions of changes in state as determined at step 310. In other words, processor 111 may update the model stored in model data 152 based on the actual change in lifetime value observed in response to the sending of the selected communication, so that the model stored in model data 152 can better predict changes in lifetime value given a set of possible communications to send. The more accurately the model can predict the result of sending a communication in terms of a change to a state of lifetime value, the more accurately processor 111 can select a communication that will maximise the increase in lifetime value between a current state and a next possible state.

Having updated the model, processor 111 may return to step 310, selecting a new message to send based on the updated model.

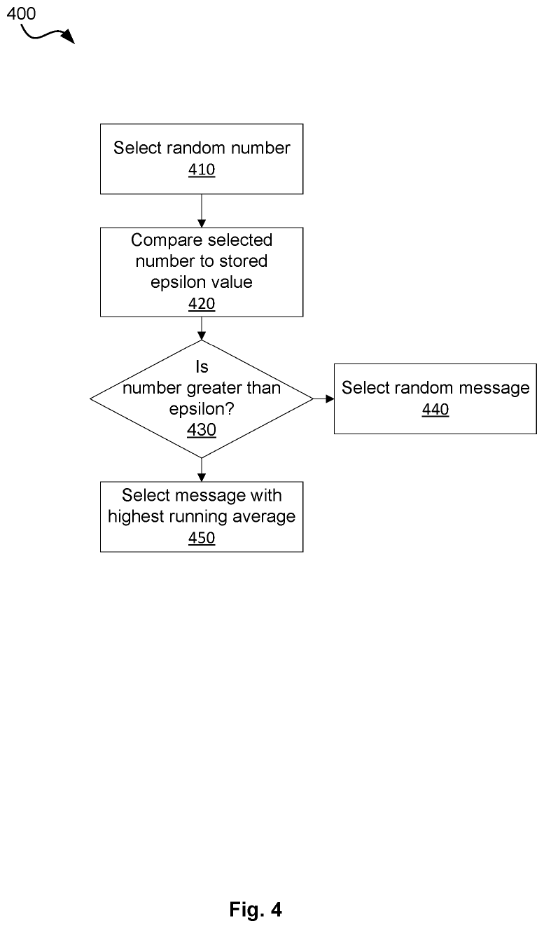

FIG. 4 shows a flow diagram illustrating a method 400 of selecting a message to send, as performed by processor 111 of sender system 110 executing instructions stored in memory 112. In particular, method 400 may be performed by processor 111 during step 210 of method 200 or step 305 of method 300, while processor 111 is executing message selection module 141. Method 400 specifically relates to an epsilon-greedy algorithm for message selection.

At step 410, processor 111 executing message selection module 141 is caused to select a random number. According to some embodiments, the random number may be selected from a uniform distribution.

At step 420, the random number selected by processor 111 is compared to a previously determined epsilon value, which processor 111 may retrieve from memory 112. The epsilon value may be selected in order to provide a balance between “exploring” and “exploiting” actions, as described above. For example, an epsilon value of 0.1 will cause an exploration to be performed on average once in every 10 messages selected, while an epsilon value of 0.5 will cause an exploration to be performed on average once in every two messages selected.

At step 430, processor 111 determines whether the selected number is greater than the epsilon value. If the number is not greater than the epsilon value, then at step 440, processor 111 will simply select a random message from message data 151 to be sent.

If the number is greater than the epsilon value, then at step 440, processor 111 will select the message from message data 151 that has the highest associated running average, as calculated at step 240 as described above. Processor 111 may then continue method 200 with the selected message.

The selection of a communication using the epsilon-greedy method of FIG. 4 may mathematically be represented as:

$${A}_{t} ≐ {arg max}_{a} {Q}_{t} ( a ) ,$$

Where Aₜ is the communication selected at a time T, and Qₜ is the value or reward of sending a communication a at time t. The algorithm selects the communication that maximises the reward.

FIG. 5 shows a flow diagram illustrating an alternative method 500 of selecting a message to send, as performed by processor 111 of sender system 110 executing instructions stored in memory 112. In particular, method 500 may be performed by processor 111 during step 210 of method 200 or step 305 of method 300, while processor 111 is executing message selection module 141. Method 500 specifically relates to a Thompson sampling algorithm for message selection.

At step 510, processor 111 executing message selection module 141 is caused to determine a beta distribution for each message stored in message data 151 using the a and B parameters as determined at step 240 of method 200 as the shape parameters of the distribution.

At step 520, processor 111 executing message selection module 141 is caused to sample from each of the distributions determined at step 510 to determine an expected success rate of that message. In other words, processor 111 is caused to select a random number from the beta distribution for each message.

At step 530, processor 111 executing message selection module 141 is caused to select the message with the highest sampled value based on the samples taken at step 540. As messages with higher past rates of success will have a higher likelihood of having a higher value selected when their distribution is sampled, selecting the message with the highest sampled value is more likely to result in a message with a higher past history of success being selected. Processor 111 may then continue method 200 with the selected message.

The selection of a communication using the Thompson sampling method of FIG. 5 is similar to Bayesian modelling. Prior distributions expressing the belief of each outcome are stated up front and combined with the likelihood distribution from observed data to obtain the posterior distribution. The posterior distribution then becomes the prior distribution in the next step as the process is repeated. This can be represented mathematically as:

$${ℙ}_{p , q} ( θ = u \vert {x}_{t} , {y}_{t} ) = \frac{p ( u ) {q}_{u} ( {y}_{l} \vert {x}_{l} )}{{\sum }_{υ} p ( υ ) {q}_{υ} ( {y}_{t} \vert {x}_{t} )} .$$

where p(u) is the prior probability of taking action u, qᵤ(y|x) is the reward distribution or likelihood, and P_{p,q}(θ|x,t) is the posterior distribution.

The beta prior may be said to be a conjugate prior of the posterior, as they both are from the same beta distribution (albeit with different parameter values).

FIG. 6 shows a flow diagram illustrating a further alternative method 600 of selecting a message to send, as performed by processor 111 of sender system 110 executing instructions stored in memory 112. In particular, method 600 may be performed by processor 111 during step 210 of method 200 or step 305 of method 300, while processor 111 is executing message selection module 141. Method 600 specifically relates to a contextual Thompson sampling algorithm for message selection, which takes into account additional contextual information such as a recipient's historical behaviour, demographics, or location.

Method 600 is based on Bayesian Logistic Regression, which is described below to provide some context to method 600.

In logistic regression, we have:

$$P ( y = 1 \vert x , w ) = σ ( {w}^{⊤} x ) = 1 / ( 1 + {e}^{- {w}^{⊤} x} ) .$$

Where x is the feature vector (the ‘context’ or independent variables), y is the binary outcome variable and w are the ‘coefficients’ or weights that we are trying to estimate.

Typically, the objective is to find weights w such that:

$${w}^{*} = {arg max}_{w} [ log P ( y \vert X , w ) - λ {w}^{⊤} w ] .$$

which is effectively finding the values of w that maximises the likelihood of log P(y|x, w)). Note that the term above includes a regularisation term, being the lambda term.

With Bayesian Logistic Regression, the problem is framed using Bayes' rule, where the objective is to now find the posterior distribution of the weights w given a prior of the weights and the likelihood of observing the data. More specifically:

$$p ( w \vert 𝒟 ) = \frac{P ( 𝒟 \vert w ) p ( w )}{P ( 𝒟 )} ∝ P ( 𝒟 \vert w ) p ( w ) .$$

where D is the observed or training data. One of the main challenges of Bayesian methods in general is that the calculation of the posterior p(w|D) requires the calculation of the normalisation term p(D) which involves an integral:

$$P ( 𝒟 ) = \int P ( 𝒟 \vert w ) p ( w ) dw .$$

For logistic regression, this integral does not have a closed form solution. One way of calculating the posterior is to approximate this it using Laplace approximations which results in:

$$p ( w \vert 𝒟 ) \approx 𝒩 ( w ; {w}^{*} , {H}^{- 1} )$$

where w* is the mode of the distribution and H is the Hessian matrix. Based on this, given a set of training samples, the weights w can be approximated by a (multivariate) normal distribution with the mean given by the average value of the weights and the variance (or covariance matrix) given by the second order derivatives (or Hessians).

Returning to method 600, at step 610, processor 111 executing message selection module 141 is caused to set the prior values of the weight means w* and covariance H for each message stored in message data 151. If such values have already previously been calculated and/or updated at step 240 of method 200, processor 111 may instead retrieve the previously derived values from memory 112.

At step 620, processor 111 executing message selection module 141 is caused to sample some values of weights w using w* and H. This may comprise randomly selecting a value of w for each message stored in message data 151.

At step 630, processor 111 executing message selection module 141 is caused to calculate the probability of each message in message data 151 being selected based on the sampled w. This probability may be determined using p(y=/| x,w), as described above.

At step 640, processor 111 executing message selection module 141 is caused to select the message with the highest probability as calculated at step 630.

Processor 111 may then continue method 200 with the selected message.

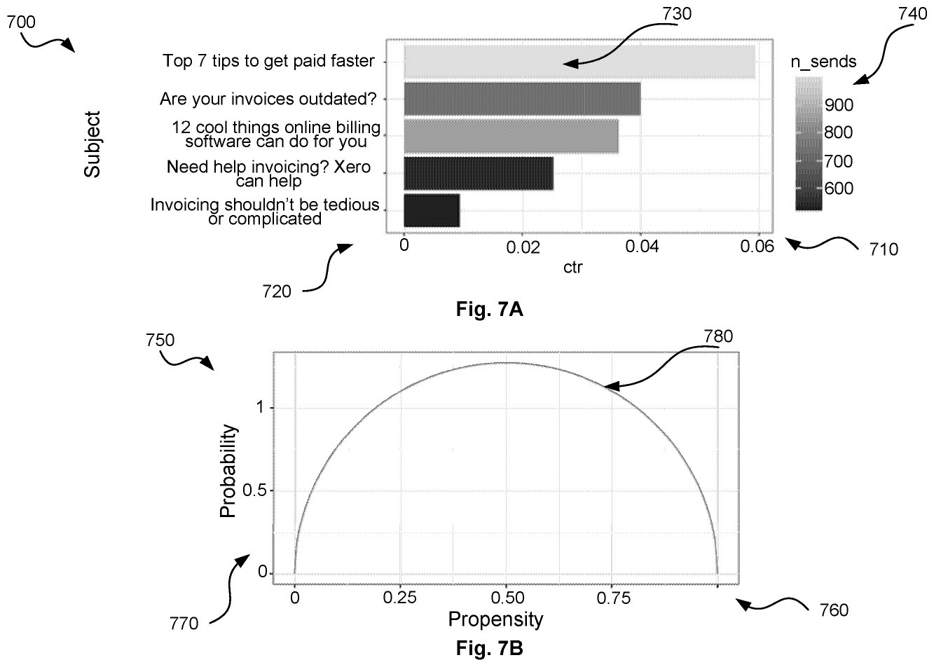

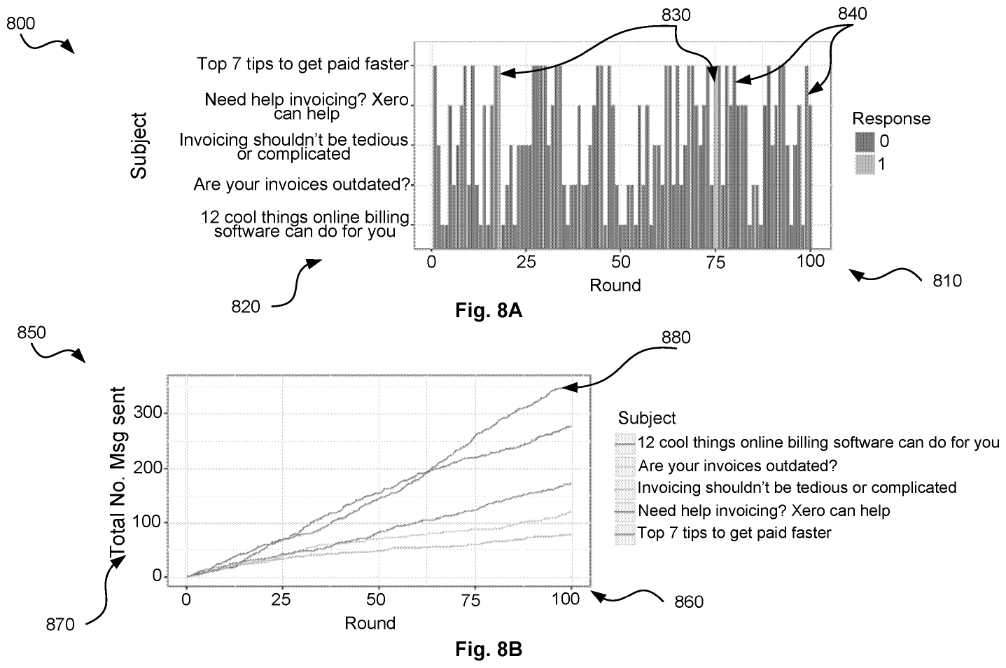

FIGS. 7A, 7B, 8A and 8B show graphs relating to an experiment performed by implementing the methods of FIGS. 2 and 5. In the experiment, a record of emails sent by an organisation to various recipients was obtained. A subset of emails that related to ‘getting paid’ were selected. For each email, a number of times the email was sent and the number of times that the email was ‘clicked’ were identified, where a click corresponded to a recipient clocking on a call to action within the email. Such a click was defined to be a successful engagement with the email.

FIG. 7A shows a bar chart 700 illustrating the subset of emails selected for their experiment. Y-axis 720 shows the subject lines of each email, which are “Top 7 tips to get paid faster”; “Are your invoices outdated?”; “12 cool things online billing software can do for you”; “Need help invoicing? Xero can help” and “Invoicing shouldn't be tedious or complicated”. X-axis 710 shows the click-through rate of each email, with “Top 7 tips to get paid faster” having the highest rate of almost 0.06. Key 740 shows the number of sends for each email, with “top 7 tips to get paid faster” having the highest sent rate of around 1000 times.

FIG. 7B shows a graph 750 illustrating the prior distribution used for each message for the purpose of performing method 500. X-axis 760 shows the propensity and y-axis 770 shows the probability, with line 780 defining the beta distribution.

Method 200 was performed 100 times, using method 500 to select the message to send. The results of the experiment are shown in FIG. 8A.

FIG. 8A shows a bar chart 800 illustrating the result of the 100 trials. X-axis 810 shows the number of trials, and y-axis 820 shows the message selected in each trial. The bars of the chart are coded to show that bars 830 resulted in successful responses, while bars 840 resulted in unsuccessful responses.

Method 200 was then performed 1000 times, using method 500 to select the message to send. The results of the experiment are shown in FIG. 8B.

FIG. 8B shows a graph of the cumulative number of times each message was selected. X-axis 860 shows the number of trials, and y-axis 870 shows the total number of times each message was sent. Lines 880 show the results for each message. While all 5 messages are sent in relatively equal proportions to begin with, this starts to separate after around 100 messages. After 1000 messages, it is clear that “Top 7 tips to get paid faster” was sent the most number of times, which corresponds with the known click though rate of that message.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for sending a communication to a recipient device, the method comprising:
selecting an initial communication from a subset of communications based on a selection algorithm, wherein the selection algorithm uses at least one stored parameter;
sending a selected communication to the recipient device;
observing any actions taken by a recipient in response to the communication;
determining whether the communication resulted in a successful outcome; and
updating the at least one stored parameter based on an observed action;
wherein a successful outcome is determined based on comparing the actions taken by the recipient in response to the communication with one or more desired actions.

2. The method of claim 1, where the selection algorithm comprises a weighted selection method.

3. The method of claim 2, wherein the weighted selection method comprises an epsilon-greedy method.

4. The method of claim 3, wherein the stored parameter comprises a running average parameter, and where the running average parameter stores a number of times each communication has had a successful outcome divided by a number of times the communication has been sent.

5. The method of claim 2, wherein the weighted selection method comprises a Thompson sampling method.

6. The method of claim 5, wherein the stored parameter comprises at least one parameter of a beta distribution.

7. The method of claim 6, wherein the stored parameter comprises an alpha parameter equivalent to a number of times the communication has had a successful outcome.

8. The method of claim 6, wherein the stored parameter comprises a beta parameter equivalent to a number of times the communication has had an unsuccessful outcome.

9. The method of claim 2, wherein the weighted selection method comprises a contextual Thompson sampling method, and the at least one stored parameter is updated using a Laplace approximation.

10. The method of claim 9, wherein the stored parameter comprises at least one parameter of a multivariate normal distribution.

11. The method of claim 10, wherein the stored parameter comprises a mode of a multivariate normal distribution.

12. The method of claim 10, wherein the stored parameter comprises a Hessian matrix.

13. The method of claim 2, wherein the weighted selection method comprises a Bernoulli method.

14. The method of claim 1, wherein observing any actions taken by the recipient in response to the communication comprises observing whether any data is received from the recipient device in response to the communication.

15. The method of claim 1, wherein observing any actions taken by the recipient in response to the communication comprises observing a change in a calculated lifetime value of a user account associated with the recipient device.

16. The method of claim 15, further comprising calculating a lifetime value of the user account based on at least one of: how long the user account has been active; how often a user logs into their account; which features the user uses; how often a user spends money; and how much money the user spends.

17. The method of claim 1, wherein the at least one stored parameter is part of a stored model, and wherein updating the at least one stored parameter based on the observed action comprises updating the stored model based on the observed action.

18. (canceled)

19. A computer-readable storage medium for sending a communication to a recipient device, the computer-readable storage medium storing executable instructions configured to, when executed by a processor, cause the processor to:
select an initial communication from a subset of communications based on a selection algorithm, wherein the selection algorithm uses at least one stored parameter;
send a selected communication to the recipient device;
observe any actions taken by a recipient in response to the communication;
determine whether the communication resulted in a successful outcome; and
update the at least one stored parameter based on an observed action;
wherein a successful outcome is determined based on comparing the actions taken by the recipient in response to the communication with one or more desired actions.

20. A system for sending a communication to a recipient device, the system comprising a computer-readable storage medium for sending a communication to a recipient device, the computer-readable storage medium storing executable instructions configured to, when executed by a processor, cause the processor to:
select an initial communication from a subset of communications based on a selection algorithm, wherein the selection algorithm uses at least one stored parameter;
send a selected communication to the recipient device;
observe any actions taken by a recipient in response to the communication;
determine whether the communication resulted in a successful outcome; and
update the at least one stored parameter based on an observed action;
wherein a successful outcome is determined based on comparing the actions taken by the recipient in response to the communication with one or more desired actions.

21. A system for sending a communication to a recipient device, the system comprising a computing device, the computing device comprising:
a processor; and
a computer-readable storage medium for sending a communication to a recipient device, the computer-readable storage medium storing executable instructions configured to, when executed by the processor, cause the processor to:
select an initial communication from a subset of communications based on a selection algorithm, wherein the selection algorithm uses at least one stored parameter;
send a selected communication to the recipient device;
observe any actions taken by a recipient in response to the communication;
determine whether the communication resulted in a successful outcome; and
update the at least one stored parameter based on an observed action;
wherein a successful outcome is determined based on comparing the actions taken by the recipient in response to the communication with one or more desired actions.
